(19) United States
(12) Patent Application Publication
(10) Pub. No.: US 2005/0289595 A1
(43) Pub. Date: Dec. 29, 2005

(54) Processing controller, data processor, processing controlling method, program thereof and recording medium storing the program

(75) Inventors: Harumi Nakamura, Tokorozawa-shi (JP); Koji Matsuura, Tokorozawa-shi (JP); Motooki Sugihara, Tsurugashima-shi (JP); Masahiro Kudo, Tokorozawa-shi (JP); Wakako Nagata, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/142,657

(22) Filed: Jun. 2, 2005

(30) Foreign Application Priority Data
Jun. 2, 2004 (JP) 2004-164932

(51) Int. Cl. G06F 13/00; G06F 3/00; H04N 5/445

(52) U.S. Cl. 725/45; 725/52

(57) ABSTRACT

On retrieving manual recording reservation request information, a CPU 290 of a storing/reproducing apparatus 200 generates manual reservation information in which recording start date/time information, recording end date/time information and the like are described and incorporates the manual reservation information in manual reservation list information. On retrieving automatic recording reservation request information, the CPU 290 generates, based on EPG data retrieved in advance, automatic reservation information in which recording start date/time information, recording end date/time information and the like of contents corresponding to a keyword of the automatic recording reservation request information are described and incorporates the automatic reservation information in automatic reservation list information. The CPU 290 retrieves one automatic reservation information from the automatic reservation list information and judges overlapping state of recording reservation between the automatic reservation information and the manual reservation information incorporated in the manual reservation list information.

### BACKGROUND OF THE INVENTION

1. Field of the Invention

The present invention relates to a processing controller, a data processor, a processing controlling method, a program thereof and a recording medium storing the program for controlling a process for retrieving data.

2. Description of Related Art

Conventionally, there has been known a storing/reproducing apparatus that accepts a recording reservation of contents such as a television program and searches for a recording reservation that overlaps with the accepted recording reservation (see Patent Document 1: Japanese Patent Laid-Open Publication Hei. 11-136615 and Patent Document 2: Japanese Patent Laid-Open Publication No. 2002-94916, for instance).

In the storing/reproducing apparatus disclosed in the Patent Document 1, a recording reservation management apparatus connected to a VTR (storing/reproducing apparatus) working as an image storage unit displays program information transmitted as television signals from a TV broadcasting station on a monitor or the like. Then, a reservation information management unit of the recording reservation management apparatus stores the program information of a program specified by a user via a remote controller in a reservation information storage as program reservation information in order to set a recording reservation. When the recording reservation is directly set to the image storage unit, the program reservation information is output to the reservation information management unit of the recording reservation management apparatus. Then, the reservation information management unit adds the program information obtained from an EPG (Electric Program Guide) to the program reservation information from the image storage to store in the reservation information storage. The reservation information management unit judges whether or not the program reservation information input from the image storage unit overlaps with the program reservation information being stored in the reservation information storage in terms of time.

In the storing/reproducing apparatus disclosed in the Patent Document 2, recording reservation setting information related to contents A to be reserved for recording is written in a RAM. This recording reservation setting information is then compared with the recording reservation setting information of contents B being stored in the RAM, and if their time zones overlap with each other, a message to inquire whether the user wants to set priority on the recording reservations will be displayed.

In the above-described conventional arrangements according to the Patent Documents 1 and 2, a plurality of information related to the recording reservations that are different from each other are collectively managed in a storing section such as the reservation information storage and the RAM. Accordingly, when judging whether the newly accepted recording reservation overlaps with the already accepted recording reservation, all information stored in the storing section needs to be judged, which is disadvantageous.

### SUMMARY OF THE INVENTION

An object of the present invention is to provide a processing controller, a data processor, a processing controlling method, a program thereof and a recording medium storing the program for appropriately retrieving data.

According to the present invention, a processing controller that retrieves predetermined data by a data retriever for retrieving the data includes a request information retrieving section that retrieves request information for requesting the data related to a specific detail or the data related to a prespecified detail to be retrieved by the data retriever; a detail information retrieving section that retrieves detail information corresponding and relating to the detail of the data to be retrieved by the data retriever based on the request information; a list table establishing section that establishes a first list table of table structure in which a plurality of the detail information corresponding to the data of the specific detail can be listed and a second list table of table structure in which a plurality of the detail information corresponding to the data of the predetermined detail can be listed; a selecting section that selects and retrieves any one of the detail information listed in the second list table; a judging section that judges an overlapping state between the detail information listed in the first list table and the detail information selected by the selecting section; and a retrieving controller that retrieves the data by the data retriever based on the detail information listed in the first list table and the detail information selected by the selecting section when the judging section judges that the details do not overlap, and selects another detail information by the selecting section when the judging section judges that the details overlap by the judging section.

A data processor according to the present invention includes the above-described processing controller of the present invention, the data retriever, a storing section for storing the data retrieved by the data retriever.

A processing controlling method of the present invention retrieves predetermined data by a data retriever for retrieving the data under control of an operating section, the operating section performing the steps of: retrieving request information for requesting the data related to a specific detail or the data related to a prespecified detail to be retrieved by the data retriever; retrieving detail information corresponding and relating to the detail of the data to be retrieved by the data retriever based on the request information; establishing a first list table of table structure in which a plurality of the detail information corresponding to the data of the specific detail can be listed and a second list table of table structure in which a plurality of the detail information corresponding to the data of the predetermined detail can be listed; selecting and retrieving any one of the detail information listed in the second list table; judging an overlapping state between the detail information listed in the first list table and the detail information selected by the selecting section; and retrieving the data by the data retriever based on the detail information listed in the first list table and the detail information selected by the selecting section when it is judged that the details do not overlap, and selecting another detail information by the selecting section when it is judged that the details overlap by the judging section.

In a processing controlling program according to the present invention, an operating section functions as the above described processing controller of the present invention.

In a processing controlling program according to the present invention, an operating section executes the above-described processing controlling method of the present invention.

In a recording medium according to the present invention, the above-described processing controlling program of the present invention is recorded readably by an operating section.

### BRIEF DESCRIPTION OF THE DRAWINGS

FIG. 1 is a block diagram schematically showing an arrangement of a contents recording/reproducing system according to an embodiment of the present invention;

FIG. 2 is a schematic illustration showing an arrangement of a memory according to the embodiment;

FIG. 3 is a schematic illustration showing an arrangement of a CPU of a storing/reproducing apparatus according to the embodiment;

FIG. 4 is a flowchart showing a process for generating automatic reservation information in association with a process for retrieving automatic recording reservation request information according to the embodiment;

FIG. 5 is another flowchart showing a process for generating automatic reservation information in association with a process for retrieving new EPG data according to the embodiment;

FIG. 6 is another flowchart showing a process for generating manual reservation information according to the embodiment; and

FIG. 7 is another flowchart showing a process for setting a recording reservation according to the embodiment.

### DETAILED DESCRIPTION OF PREFERRED EMBODIMENTS

An embodiment of the present invention will be described below with reference to attached drawings. Although, a storing/reproducing apparatus provided with a data processor having a processing controller of the present invention will be explained as an example, the present invention is not limited thereto and any arrangement for retrieving information may be employed. Note that, in the embodiment, a process for storing contents is arbitrarily referred to as a recording process and explained. Recording start date/time information, recording end date/time information, channel information and the like, which are set by manual setting by a user, are retrieved. The recording start date/time information and the recording end date/time information function as detail information and delivery time information of the present invention. A recording reservation for a television program identified by various information is arbitrarily referred to as a manual recording reservation and explained. Moreover, a keyword that is character information as request information set based on the manual input by the user is recognized. The recording reservation of the television program related to the keyword recognized by referring to, for instance, EPG (Electric Program Guide) data (described later) is referred to as an automatic recording reservation and explained.

[Arrangement of Contents Recording/Reproducing System]

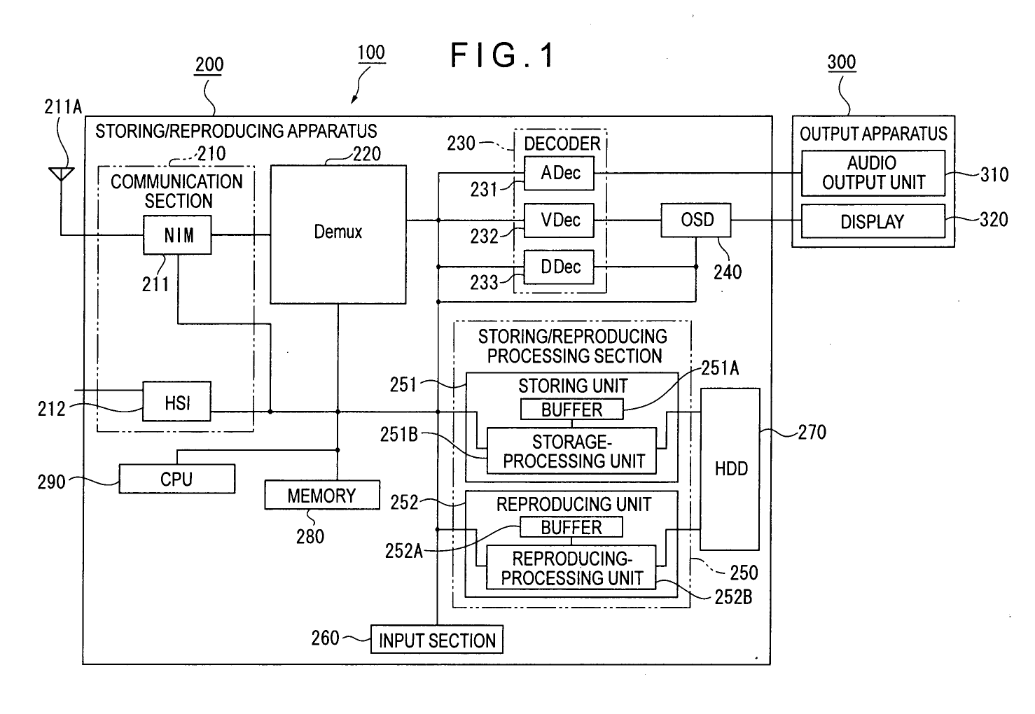

FIG. 1 shows a contents recording/reproducing system (hereinafter referred to as a recording/reproducing system) 100 that records contents data having audio data, video data, data for data broadcasting, etc. of contents such as a television program, and reproduces the stored contents data. The recording/reproducing system 100 includes a storing/reproducing apparatus 200 and an output apparatus 300.

The output apparatus 300 may be a personal computer, a TV set, a cellular telephone, a PDA (Personal Digital Assistant), for example. The output apparatus 300 receives the contents that is input from the storing/reproducing apparatus 200 and outputs it. The output apparatus 300 includes an audio output unit 310 and a display 320, etc.

The audio output unit 310 has a sound-producing section such as a speaker (not shown). The audio output unit 310 outputs the audio data sent from the storing/reproducing apparatus 200 as analog signals as sounds from the sound-producing section. The sound-producing section can output, for example, TV audio data received by a TV receiver (not shown).

The display 320 displays the video data, the data for broadcasting, the EPG data, synthesized data, etc. sent from the storing/reproducing apparatus 200 as analog signals. The video data to be displayed may be images of the contents. The data for broadcasting to be displayed may be subtitles of the contents, data broadcasting, etc. The EPG data to be displayed may be a program list in which program name, detail, broadcasting start date/time, etc. of the contents to be broadcasted on respective channels are listed. As the synthesized data, synthesized images having the images of the contents and the subtitles superposed thereon and images having the data broadcasting and the program list that are laid out side-by-side can be exemplified. The display 320 may be a liquid crystal display panel, an organic EL (Electro Luminescence) panel, a PDP (Plasma Display Panel), a CRT (Cathode-Ray Tube), an FED (Field Emission Display), an electrophoretic display panel, etc. The display 320 can output the TV video data received by the TV receiver, for example.

The storing/reproducing apparatus 200 retrieves, records and outputs from the output apparatus 300 the contents data having the audio data, the video data, the data for data broadcasting, etc. which are delivered as a TS (Transport Stream) from a broadcasting station (not shown) working as a delivery section. The storing/reproducing apparatus 200 also reproduces the recorded contents data and outputs it from the output apparatus 300. In addition, the storing/reproducing apparatus 200 automatically deletes the recorded contents data. The storing/reproducing apparatus 200 includes a communication section 210, a demultiplexer (Demux) 220, a decoder 230, an on-screen display (OSD) 240, a storing/reproducing processing section 250, an input section 260, a hard disk drive (HDD) 270, a memory 280 as a storing section, a central processing unit (CPU) 290 as an operating section, etc.

The communication section 210 retrieves the contents data input from the outside, and arbitrarily outputs the contents data to the outside. The communication section 210 includes a network interface module (NIM) 211, a high speed interface (HSI) 212, etc.

The NIM 211 is connected to an antenna 211A that receives broadcast waves such as terrestrial digital broadcasting and satellite digital broadcasting. The NIM 211 is connected to the Demux 220, CPU 290, etc. The NIM 211 retrieves the TS corresponding to the contents selected by the user from a plurality of the TSs sent from the antenna 211A as digital signals under the control of the CPU 290. Then, the NIM 211 outputs the retrieved TS to the Demux 220.

The HSI 212 may be an interface of the IEEE (Institute of Electrical and Electronics Engineers) 1394 standard capable of high speed data processing. The Demux 220, the storing/reproducing processing section 250, etc. are connected to the HSI 212. The HSI 212 retrieves the TS and a partial TS (described later) that are transmitted as digital signals from an external device (not shown) disposed outside the storing/reproducing apparatus 200, and sends the TS and the partial TS to the Demux 220. The HSI 212 retrieves and processes the partial TS that is output from the storing/reproducing processing section 250 and transmits the processed partial TS to the external device (not shown) disposed outside the storing/reproducing apparatus 200 as digital signals.

The Demux 220 retrieves the TS, demultiplexes TS packets from the TS and outputs the packets. The decoder 230, the storing/reproducing processing section 250, the CPU 290, etc. are connected to the Demux 220. The Demux 220 retrieves the TS from the NIM 211 and HSI 212 under the control of the CPU 290. From the TS, the Demux 220 retrieves the TS packets of respective data corresponding to selected contents. Specifically, the Demux 220 retrieves the TS packets in which the audio data is embedded (referred to as audio packets, hereinafter), the TS packets in which the video data is embedded (referred to as video packets, hereinafter), the TS packets in which the data for data broadcasting and the EPG data are embedded (referred to as data packets, hereinafter). Then, the Demux 220 outputs the retrieved audio packets, video packets, and data packets to the decoder 230.

The EPG data is data in which information of each TS which can be retrieved by the NIM 211 (i.e. information of the contents such as the television program) is written in a text format such as the BML (Broadcast Markup Language) and XML (Extensible Markup Language). Specifically, the EPG data is of table structure in which a plurality of program related information of respective programs are configured to be one data. The program related information is of table structure in which information such as program name, broadcasting start date/time, length of program air time, channel number, program description concerning detail of the program, genre, series name, etc. are configured to be one data. The information concerning the broadcasting start date/time and the length of program air time function as detail information and delivery time information of the present invention.

Furthermore, when retrieving respective TS packets corresponding to selected contents from the retrieved TS under the control of the CPU 290, the Demux 220 reconstructs the respective TS packets into the TS of serial data string structure, i.e. into the partial TS. Then the Demux 220 outputs the partial TS to the storing/reproducing processing section 250. The Demux 220 also retrieves the partial TS from the HSI 212 and the storing/reproducing processing section 250 under the control of the CPU 290. Then, the Demux 220 demultiplexes the audio packets, the video packets and the data packets from the partial TS and outputs to the decoder 230.

The decoder 230 is connected to the OSD 240, the CPU 290, the output apparatus 300, etc. The decoder 230 retrieves respective packets from the Demux 220, and arbitrarily outputs respective data embedded in the respective packets to the OSD 240 and the output apparatus 300. The decoder 230 includes an audio decoder (ADec) 231, a video decoder (VDec) 232, and a data decoder (DDec) 233.

The ADec 231 is connected to the audio output unit 310 of the output apparatus 300. The ADec 231 retrieves the audio packets from the Demux 220 under the control of the CPU 290. Then, the ADec 231 demodulates the audio data embedded in the audio packets, and transmits the data to the audio output unit 310 of the output apparatus 300 as analog signals.

The VDec 232 is connected to the OSD 240. The VDec 232 retrieves the video packets from the Demux 220 under the control of the CPU 290. Then, the VDec 232 demodulates the video data embedded in the video packets and outputs the data to the OSD 240.

The DDec 233 is connected to the OSD 240. The DDec 233 retrieves the data packets from the Demux 220 under the control of the CPU 290. Then, the DDec 233 demodulates the data for data broadcasting, the EPG data, etc. embedded in the data packets, and outputs the data to the OSD 240. When the EPG data is embedded in the data packets, the DDec 233 arbitrarily outputs the EPG data to the HDD 270 under the control of the CPU 290.

The OSD 240 is connected to the CPU 290, the display 320 of the output apparatus 300, etc. The OSD 240 retrieves the video data from the VDec 232 under the control of the CPU 290. The OSD 240 also retrieves the data for data broadcasting, the EPG data, etc. from the DDec 233. Then, the OSD 240 selectively superposes i.e. lays out side-by-side images based on the video data, subtitles etc. based on the data for data broadcasting, a program list, etc. based on the EPG data so as to generate the synthesized data to be displayed. Then, the OSD 240 transmits the generated synthesized data to the display 320 of the output apparatus 300 as analog signals. Further, the OSD 240 separately outputs the video data, the data for data broadcasting and the EPG data to the display 320 as analog signals.

The storing/reproducing processing section 250 is connected to the HDD 270, the CPU 290, etc. The storing/reproducing processing section 250 retrieves the partial TS from the Demux 220, and stores it in the HDD 270. The storing/reproducing processing section 250 also retrieves the partial TS stored in the HDD 270, and outputs it to the HSI 212 and the Demux 220. The storing/reproducing processing section 250 includes a storing unit 251 as a data retriever and a reproducing unit 252.

The storing unit 251 stores the partial TS from the Demux 220 in the HDD 270. The storing unit 251 includes a buffer 251A, a storage-processing unit 251B, etc. The buffer 251A temporarily stores the partial TS from the Demux 220. The storage-processing unit 251B retrieves the partial TS from the Demux 220 and readably stores in the buffer 251A under the control of the CPU 290. Then, the storage-processing unit 251B arbitrarily reads out the partial TS stored in the buffer 251A and outputs it to the HDD 270.

The reproducing unit 252 arbitrarily outputs the partial TS stored in the HDD 270 to the HSI 212 and the Demux 220. The reproducing unit 252 includes a buffer 252A, a reproducing-processing unit 252B, etc. The buffer 252A temporarily stores the partial TS from the HDD 270. The reproducing-processing unit 252B retrieves the partial TS from the HDD 270 and readably stores it in the buffer 252A under the control of the CPU 290. Then, the reproducing-processing unit 252B arbitrarily reads out the partial TS stored in the buffer 252A and outputs it to the HSI 212 and the Demux 220.

The input section 260 is connected to the CPU 290, etc. The input section 260 has various operation buttons and operation knobs (not shown) that are operably arranged on, for instance, a front side of a case (not shown) to be used for inputting. By inputting using the operation buttons and the operation knobs, the storing/reproducing apparatus 200 can be set. Specifically, details in recoding and reproducing the contents and which TS is to be received by the NIM 211 can be set. Then, based on the input, the input section 260 sends various information to the CPU 290 as operation signals to perform the setting. The input section 260 may have a remote control optical unit that receives the various information transmitted from a remote controller (not shown) via infrared rays, and transmits the information to the CPU 290 as operation signals.

The HDD 270 is connected to the CPU 290, etc. The HDD 270 is controlled by an ATA (AT Attachment) interface. In this embodiment, the HDD 270 is controlled by the ATA interface, but any arrangement in which the HDD 270 is controlled by an IDE (Integrated Drive Electronics) interface or an SCSI (Small Computer System Interface) interface may be employed. Furthermore, instead of the HDD 270, a drive or a driver that readably stores various information in a recording medium such as a DVD (Digital Versatile Disc), an optical disc and a memory card may be used. The HDD 270 readably stores the partial TS such as the contents data and the EPG data of the contents input from the storing unit 251.

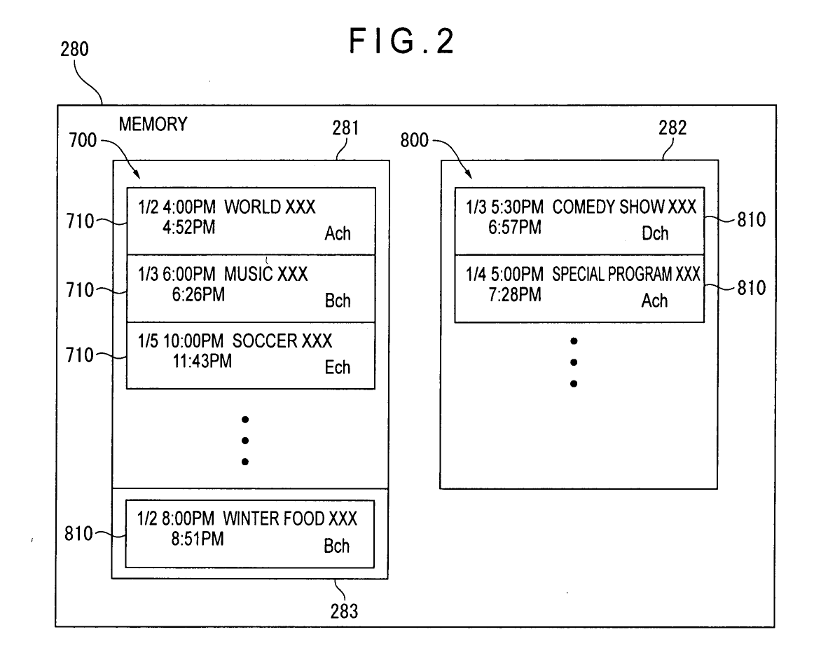

The memory 280 readably stores various data that is necessary when retrieving and storing the desired contents data from the TS output from the NIM 211, or when reproducing the recorded contents data. The memory 280 has a manual reservation list storage region 281 in which manual reservation list information 700 as a first list table is stored, an automatic reservation list storage region 282 in which automatic reservation list information 800 as a second list table is stored, a reservation information temporary storage region 283 as a selected-object information table in which automatic reservation information is stored, and a keyword storage region (not shown) in which a keyword that is input by the user is stored, as shown in FIG. 2.

The manual reservation list information 700 is information concerning a list of manual recording reservations. The manual reservation list information 700 is information of table structure in which at least one manual reservation information 710 is configured as one data.

In the manual reservation information 710, recording basic information such as the recording start date/time information, recording end date/time information and channel information is configured as one data. The manual reservation information 710 is incorporated in the manual reservation list information 700 by the CPU 290 when the manual recording reservation is set, and is deleted from the manual reservation list information 700 when a recording based on the manual recording reservation is completed. The manual reservation information 710 is arbitrarily sorted by the CPU 290 in the order of the recording start date/time from the earliest to latest. In other words, the manual reservation information 710 is sorted such that the manual reservation information 710 of which recording start date/time is the earliest is located at the beginning of the manual reservation list information 700, while the manual reservation information 710 of which recording start date/time is the latest is located at the end of the manual reservation list information 700.

The automatic reservation list information 800 is information concerning a list of automatic recording reservations. The automatic reservation list information 800 is information of table structure in which at least one automatic reservation information 810 is configured as one data.

In the automatic reservation information 810, recording basic information similar to that of the manual reservation information 710 is configured as one data. The automatic reservation information 810 is incorporated in the automatic reservation list information 800 by the CPU 290 when the automatic recording reservation is set. The automatic reservation information 810 is arbitrarily sorted by the CPU 290 in the order of the recording start date/time from the earliest to latest. In other words, the automatic reservation information 810 is sorted such that the automatic reservation information 810 of which recording start date/time is the earliest is located at the beginning of the automatic reservation list information 800, while the automatic reservation information 810 of which recording start date/time is the latest is located at the end of the automatic reservation list information 800. Then, the automatic reservation information 810 which is located at the beginning of the automatic reservation list information 800, i.e. the automatic reservation information 810 of which recording start date/time is the earliest is deleted from the automatic reservation list storage region 282 and stored in the reservation information temporary storage region 283. Furthermore, the automatic reservation information 810 stored in the reservation information temporary storage region 283 is deleted from the reservation information temporary storage region 283 when a recording based on the automatic recording reservation is completed, or when manual recording reservation of which recording time overlaps with that of the automatic recording reservation is already set.

The memory 280 readably stores various programs to be run on an OS (Operating System) that controls the performance of the entire storing/reproducing apparatus 200. It is desirable that the memory 280 is a memory of which storage is retained even if power supply is abruptly shut off at the time of, for example, electric power failure, that is, a CMOS (Complementary Metal-Oxide Semiconductor) memory, etc. As the memory 280, a drive or a driver that readably stores information in a recording medium such as an HD, a DVD and an optical disc may be used.

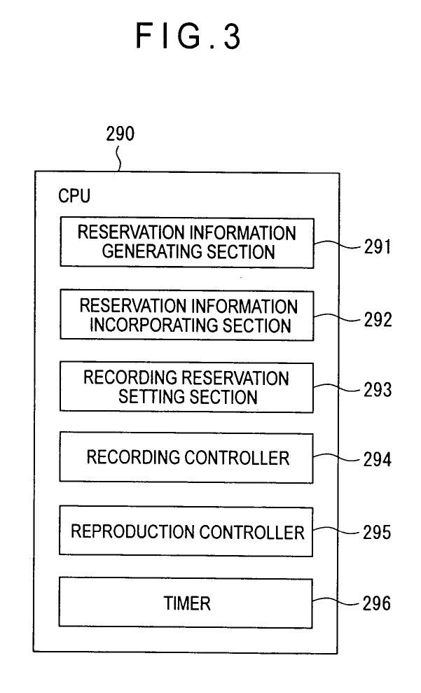

The CPU 290 includes, in a form of programs, a reservation information generating section 291 that also works as a request information retrieving section and a detail information retrieving section, a reservation information incorporating section 292 that also works as a list table establishing section, a recording reservation setting section 293 that also works as a selecting section, a judging section and a retrieving controller, a recording controller 294, a reproduction controller 295, a timer 296, etc., as shown in FIG. 3. The reservation information generating section 291, the reservation information incorporating section 292, and the recording reservation setting section 293 configure the processing controller of the present invention. Furthermore, the storing unit 251, memory 280, the reservation information generating section 291, the reservation information incorporating section 292, and the recording reservation setting section 293 configure the data processor of the present invention.

The reservation information generating section 291 retrieves the automatic recording reservation request information sent from the input section 260 as operation signals. Then, the reservation information generating section 291 performs the process for generating the automatic reservation information based on the automatic recording reservation request information. Specifically, the reservation information generating section 291 controls the DDec 233 and stores the EPG data written in the TS retrieved by the NIM 211 in the HDD 270. When retrieving the automatic recording reservation request information, the reservation information generating section 291 retrieves the keyword written in the automatic recording reservation request information and stores the keyword in the keyword storage region of the memory 280, and retrieves the EPG data stored in the HDD 270. Furthermore, the reservation information generating section 291 searches the EPG data for the contents having the program name, program description, genre, series name, etc. which are identical with or relevant to the retrieved keyword. Then, when recognizing that the contents having, for instance, the program name relevant to the keyword is found, the reservation information generating section 291 recognizes the recording basic information such as the recording start date/time information, recording end date/time information and channel information, etc. of the contents based on the EPG data, and generates the automatic reservation information 810 having written therein the recording basic information. When recognizing that a plurality of the contents relevant to the keyword are found, the reservation information generating section 291 generates the automatic reservation information 810 corresponding to the respective contents.

The reservation information generating section 291 arbitrarily controls the DDec 233 and stores the latest EPG data in the HDD 270. After storing the latest EPG data in the HDD 270, the reservation information generating section 291 deletes the automatic reservation information 810 incorporated in the automatic reservation list information 800. The reservation information generating section 291 also deletes the automatic reservation information 810 stored in the reservation information temporary storage region 283. Moreover, the reservation information generating section 291 retrieves the keyword stored in the keyword storage region of the memory 280. Then, the reservation information generating section 291 performs the same process as that of the time of retrieving the automatic recording reservation request information, and generates the automatic reservation information 810 of the contents relevant to the retrieved keyword.

Furthermore, the reservation information generating section 291 retrieves the manual recording reservation request information that is the request information sent from the input section 260 as the operation signals. Then, based on the manual recording reservation request information, the reservation information-generating section 291 performs the process for generating the manual reservation information. Specifically, when retrieving the manual recording reservation request information, the reservation information-generating section 291 recognizes the recording basic information described in the manual recording reservation request information. The reservation information generating section 291 arbitrarily generates the manual reservation information 710 having written therein the recording basic information.

The reservation information incorporating section 292 stores the manual reservation information 710 and the automatic reservation information 810 generated in the reservation information generating section 291 in the memory 280. Specifically, when at least one automatic reservation information 810 is generated in the reservation information generating section 291, the reservation information incorporating section 292 incorporates the automatic reservation information 810 in the automatic reservation list information 800 of the automatic reservation list storage region 282. Furthermore, the reservation information incorporating section 292 sorts the automatic reservation information 810 incorporated in the automatic reservation list information 800 in the order of the recording start date/time from the earliest to latest. In other words, the automatic reservation information 810 is sorted such that the automatic reservation information 810 of which recording start date/time is the earliest is located at the beginning of the automatic reservation list information 800. When the manual reservation information 710 is generated in the reservation information generating section 291, the reservation information incorporating section 292 incorporates the manual reservation information 710 in the manual reservation list information 700 of the manual reservation list storage region 281. Moreover, the reservation information incorporating section 292 sorts the manual reservation information 710 incorporated in the manual reservation list information 700 in the order of the recording start date/time from the earliest to latest.

The recording reservation setting section 293 sets the recording reservations based on the respective reservation information 710, 810. When it is recognized that the recording time of the manual reservation information 710 and that of the automatic reservation information 810 stored in the memory 280 overlap with each other, that is, the recording reservations overlap with each other, the recording reservation setting section 293 deletes the automatic reservation information 810 that overlaps with the manual reservation information 710 from the memory 280.

Specifically, when the automatic reservation information 810 of the automatic reservation list information 800 is sorted in the reservation information incorporating section 292, the recording reservation setting section 293 retrieves the automatic reservation information 810 located at the beginning of the automatic reservation list information i.e. the automatic reservation information 810 of which recording start date/time is the earliest, and stores it in the reservation information temporary storage region 283. Then, the recording reservation setting section 293 judges the overlapping state between the recording reservation of the automatic reservation information 810 stored in the reservation information temporary storage region 283 and the recording reservation of the manual reservation information 710 located at the beginning of the manual reservation list information 700 i.e. the manual reservation information 710 of which recording start date/time is the earliest. When it is determined that there is overlapping, the automatic reservation information 810 stored in the reservation information temporary storage region 283 is deleted. On the other hand, when it is determined that there is no overlapping, the recording reservation setting section 293 sequentially judges the overlapping state with the manual reservation information 710 located at the second position from the top, third position, fourth position and so on in the manual reservation list information 700 i.e. the manual reservation information 710 of which recording start date/time is second earliest, third earliest, fourth earliest and so on. Then, when the recording reservation setting section 293 judges the overlapping state with the manual reservation information 710 of which recording start date/time is later than the recording end date/time of the automatic reservation information 810, it is determined that there is no overlapping manual reservation information 710 in subsequent manual reservation information 710, ending the process for judging the overlapping state. When deleting the automatic reservation information 810 from the reservation information temporary storage region 283, the reservation information incorporating section 292 sorts the automatic reservation information 810 of the automatic reservation list information 800 under the control of the recording reservation setting section 293. Furthermore, when the reservation information incorporating section 292 sorts the manual reservation information 710 of the manual reservation list information 700, the recording reservation setting section 293 judges whether or not the recording reservation of the automatic reservation information 810 stored in the reservation information temporary storage region 283 overlaps with the recording reservation of the manual reservation information 710 incorporated in the manual reservation list information 700, performing the above-described process.

The recording controller 294 controls the operation of the NIM 211, the Demux 220, the storing unit 251 of the storing/reproducing processing section 250, etc. to receive the contents data of the desired contents and readably stores it in the HDD 270. Specifically, the recording controller 294 stores the contents data which is currently received and reproduced using the operation signals based on the input at the input section 260; or receives and stores the contents data of which recording start date/time in the respective reservation information 710, 810 is identical with the current time clocked by the timer 296 (described later) based on the manual reservation information 710 in the manual reservation list information 700 or the automatic reservation information 810 in the reservation information temporary storage region 283. Then, after performing the process for storing the contents data i.e. the recording process, the recording controller 294 deletes the manual reservation information 710 or the automatic reservation information 810 corresponding to the recording process.

The reproduction controller 295 controls the operation of the Demux 220, the decoder 230, the reproducing unit 252 of the storing/reproducing processing section 250, etc., and outputs the contents data of the desired contents to the output apparatus 300 to reproduce the contents data. Specifically, the reproduction controller 295 reads out from the HDD 270 the contents data specified by the operation signals based on the input at the input section 260 (for example, the contents data specified by the input to select thumbnails displayed in a list on the output apparatus 300) or the contents data which is requested to be reproduced at a predetermined time as a timer-reproduction, and outputs the data to the output apparatus 300 after arbitrarily processing by the decoder 230.

The timer 296 clocks the current time based on a reference pulse of such as an internal clock, and generates current time information.

[Operation of Contents Recording/Reproducing System]

Next, the operation of the recording/reproducing system 100 will be explained with reference to the drawings.

(Process for Generating Automatic Reservation Information in Retrieving Automatic Recording Reservation Request Information)

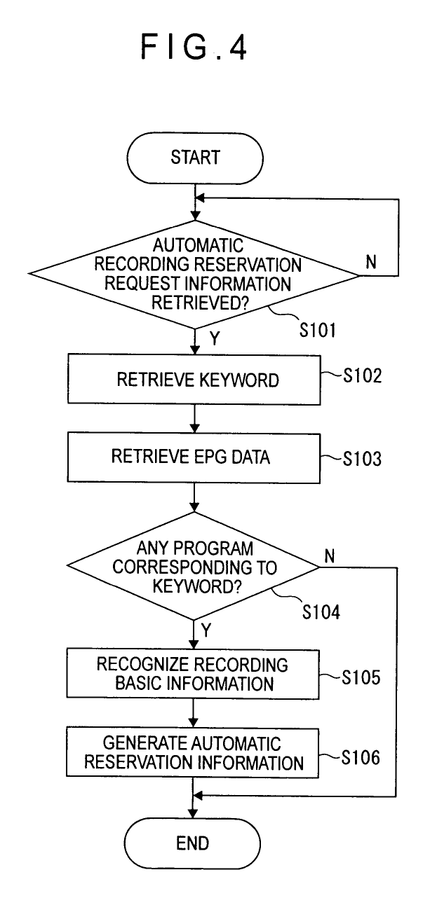

At first, as the operation of the recording/reproducing system 100, the process for generating the automatic reservation information 810 in association with the process for retrieving the automatic recording reservation request information will be explained referring to FIG. 4. FIG. 4 is a flowchart showing the process for generating the automatic reservation information in association with the process for retrieving the automatic recording reservation request information.

Firstly, the user sets the automatic recording reservation request information such as a keyword related to the program name, program details, etc. of the desired contents using, for example, the input section 260. In the storing/reproducing apparatus 200, as shown in FIG. 4, when the reservation information generating section 291 of the CPU 290 retrieves the automatic recording reservation request information (step S101), the keyword described in the automatic recording reservation request information is retrieved (step S102), and the retrieved keyword is stored in the keyword storage region of the memory 280. Then, the reservation information generating section 291 retrieves the EPG data which has been retrieved by the NIM 211 and stored in the HDD 270 (step S103). Then, it is judged whether or not there is a program corresponding to the keyword set by the user (step S104). Specifically, it is judged whether or not any contents having the program name, program description, genre, series name, etc. which are identical with or relevant to the keyword has been found from the EPG data.

In step S104, when it is determined that there is no program that corresponds to the keyword, the reservation information generating section 291 ends the process for generating the automatic reservation information 810. On the other hand, in step S104, when it is determined that there is a program that corresponds to the keyword, the reservation information generating section 291 recognizes the recording basic information such as the recording start date/time information, recording end date/time information and channel information of the contents of the program based on the EPG data (step S105). Then, the automatic reservation information 810 having written therein the recording basic information is generated (step S106), and the process is ended. In step S104, when it is determined that there are a plurality of contents corresponding to the keyword, the automatic reservation information 810 for each contents is generated in step S106.

(Process for Generating Automatic Reservation Information in Retrieving New EPG Data)

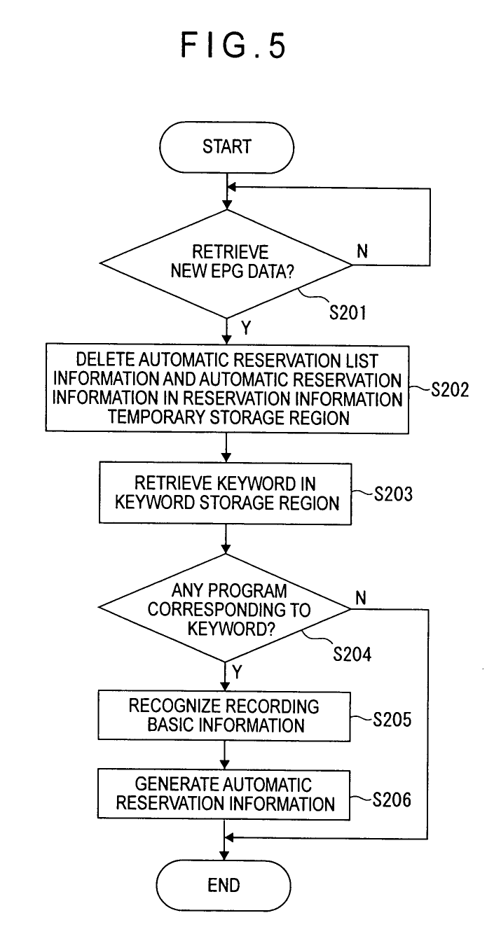

Next, as the operation of the recording/reproducing system 100, the process for generating the automatic reservation information 810 in association with the process for retrieving new EPG data will be explained referring to FIG. 5.

In the storing/reproducing apparatus 200, as shown in FIG. 5, when the reservation information generating section 291 of the CPU 290 retrieves new EPG data (step S201), the EPG data stored in the HDD 270 is updated with this retrieved new EPG data. Then, the automatic reservation information 810 incorporated in the automatic reservation list information 800 and the automatic reservation information 810 stored in the reservation information temporary storage region 283 are deleted (step S202). Then, the reservation information generating section 291 retrieves all of the keywords stored in the keyword storage region of the memory 280 (step S203), and judges whether or not there are programs corresponding to the retrieved keywords (step S204).

In step S204, when it is determined that there is no program that corresponds to the keywords, the reservation information generating section 291 ends the process for generating the automatic reservation information 810. On the other hand, in step S204, when it is determined that there is a program that corresponds to the keywords, the recording basic information of the contents of the program is recognized (step S205), and the automatic reservation information 810 having written therein the recording basic information is generated (step S206), and the process is ended.

(Process for Generating Manual Reservation Information)

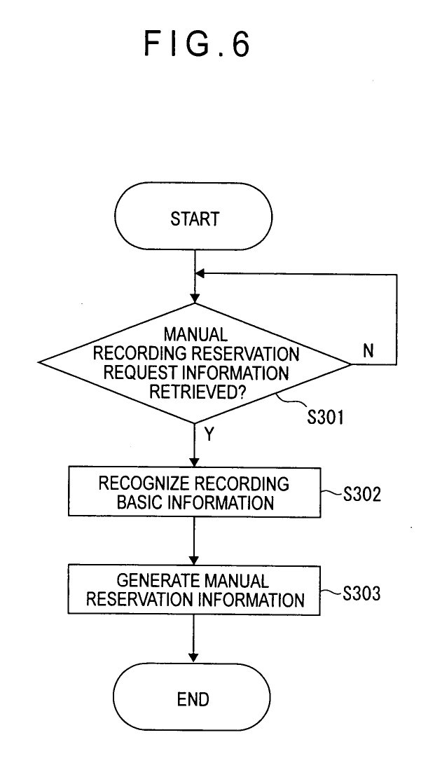

Next, as the operation of the recording/reproducing system 100, the process for generating the manual reservation information 710 will be explained referring to FIG. 6.

Firstly, the user sets the manual recording reservation request information such as the recording start date/time information, recording end date/time information, and channel information, which are necessary to set a manual recording reservation of the desired contents using the input section 260. In the storing/reproducing apparatus 200, as shown in FIG. 6, when the reservation information generating section 291 of the CPU 290 retrieves the manual recording reservation request information (step S301), the recording basic information such as the recording start date/time information, recording end date/time information, and channel information written in the manual recording reservation request information is recognized (step S302). Then, the manual reservation information 710 having written therein the recording basic information is generated (step S303), and the process is ended.

(Setting of Recording Reservation)

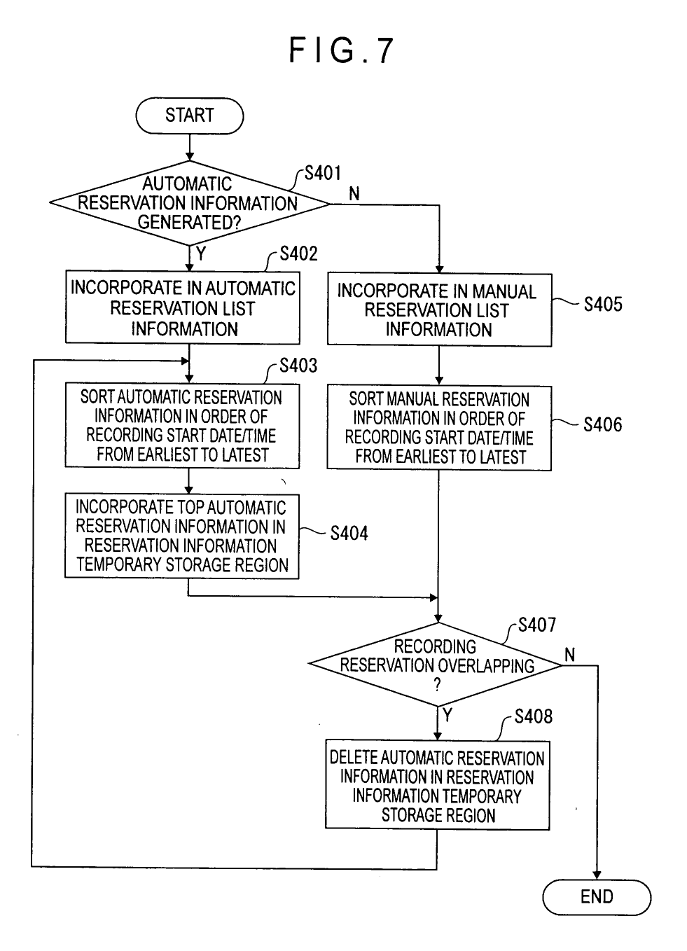

Next, as the operation of the recording/reproducing system 100, the process for setting the recording reservation will be explained referring to FIG. 7.

In the storing/reproducing apparatus 200, when the reservation information incorporating section 292 of the CPU 290 recognizes that the manual reservation information 710 or the automatic reservation information 810 is generated in the reservation information generating section 291, it is judged whether or not the generated information is the automatic reservation information 810 (step S401). In step S401, when it is determined that the automatic reservation information 810 is generated, the generated automatic reservation information 810 is incorporated in the automatic reservation list information 800 (step S402). When a plurality of the automatic reservation information 810 is generated in the reservation information generating section 291, the reservation information incorporating section 292 incorporates all of the automatic reservation information 810 in the automatic reservation list information 800. Then, the reservation information incorporating section 292 sorts the automatic reservation information 810 incorporated in the automatic reservation list information 800 in the order of the recording start date/time from the earliest to latest (Step S403). Subsequently, the recording reservation setting section 293 of the CPU 290 retrieves the automatic reservation information 810 located at the beginning of the automatic reservation list information 800, and stores the retrieved automatic reservation information 810 in the reservation information temporary storage region 283 (step S404). That is, the automatic reservation information 810 of which recording start date/time is the earliest is stored in the reservation information temporary storage region 283. On the other hand, in step S401, when it is determined that the manual reservation information 710 is generated, the reservation information incorporating section 292 incorporates the generated manual reservation information 710 in the manual reservation list information 700 (Step S405). Then, the reservation information incorporating section 292 sorts the manual reservation information 710 incorporated in the manual reservation list information 700 in the order of recording start date/time from the earliest to latest (Step S406).

When it is recognized that the process of step S404 or step S406 is performed in the reservation information incorporating section 292, the recording reservation setting section 293 retrieves the automatic reservation information 810 stored in the reservation information temporary storage region 283. In other words, it is judged whether or not the recording reservation of the retrieved automatic reservation information 810 overlaps with recording reservation of all the manual reservation information 710 incorporated in the manual reservation list information 700 (step S407). As described above, the recording reservation setting section 293 judges the overlapping state sequentially from the manual reservation information 710 located at the beginning of the manual reservation list information 700. And, when the overlapping state with the manual reservation information 710 of which recording start date/time is later than the recording end date/time of the automatic reservation information 810 is judged, the process of judging the overlapping is ended. In step S407, when it is determined that there is no overlapping, any process is not performed, ending the process for setting the recording reservation. On the other hand, in step S407, when it is determined that there is overlapping, the recording reservation setting section 293 deletes the automatic reservation information 810 stored in the reservation information temporary storage region 283 (step S408), returning to step S403.

[Effects of Contents Recording/Reproducing System]

As described above, according to the present embodiment, in the storing/reproducing apparatus 200, when the reservation information generating section 291 of the CPU 290 retrieves the manual recording reservation request information, the manual reservation information 710 having written therein recording start date/time information, recording end date/time information, etc. is generated based on the manual recording reservation request information. Then, the CPU 290 incorporates the manual reservation information 710 in the manual reservation list information 700 by means of the reservation information incorporating section 292. The CPU 290 arbitrarily stores in the HDD 270 the EPG data retrieved by the NIM 211 by means of the reservation information generating section 291. Then, when retrieving the automatic recording reservation request information, the reservation information generating section 291 recognizes the keyword of the automatic recording reservation request information, and retrieves the EPG data stored in the HDD 270. Consequently, based on the EPG data, when it is recognized that there is a program corresponding to the recognized keyword, the automatic reservation information 810 having written therein recording start date/time information, recording end date/time information, etc. of the contents of the program is generated. Then, the reservation information incorporating section 292 incorporates the automatic reservation information 810 in the automatic reservation list information 800. The CPU 290 retrieves one automatic reservation information 810 from the automatic reservation list information 800 by means of the recording reservation setting section 293, and judges the overlapping state of the recording reservation between the automatic reservation information 810 and the manual reservation information 710 incorporated in the manual reservation list information 700. Then, when it is determined that there is no overlapping, the recording reservation setting section 293 ends the process for setting the recording reservation without deleting the automatic reservation information 810, while when it is determined that there is overlapping, the recording reservation setting section 293 deletes the automatic reservation information 810 from the memory 280 and retrieves another automatic reservation information 810 to perform the above-described process.

Accordingly, since the CPU 290 of the storing/reproducing apparatus 200 judges the overlapping state between one automatic reservation information 810 retrieved from the automatic reservation list information 800 and the manual reservation information 710 of the manual reservation list information 700 by means of the recording reservation setting section 293, the number of steps in the process for judging the overlapping state and the time required for judging can be reduced as compared with the conventional arrangement in which the overlapping state with all the reservation information 710, 810 stored in the memory 280 is judged. Accordingly, the storing/reproducing apparatus 200 can properly set the recording reservation, and thus can properly retrieve the contents data of the contents reserved for recording.

In judging the overlapping state of the recording start date/time of the respective reservation information 710, 810, the recording reservation setting section 293 retrieves one automatic reservation information 810 from the automatic reservation list information 800 based on the recording start date/time information written in the automatic reservation information 810. Accordingly, since the recording reservation setting section 293 retrieves the one automatic reservation information 810 based on the recording start date/time information, the process for judging the overlapping state of the recording start date/time can be properly performed as compared with the configuration in which the automatic reservation information 810 is retrieved based on information other than the recording start date/time information such as the channel information. Thus, the storing/reproducing apparatus 200 can properly retrieve the contents data.

The reservation information incorporating section 292 sorts the automatic reservation information 810 incorporated in the automatic reservation list information 800 in the order of the recording start date/time from the earliest to latest. Then, the recording reservation setting section 293 retrieves the automatic reservation information 810 located at the beginning of the automatic reservation list information 800. Accordingly, the recording reservation setting section 293 always needs to retrieve only the automatic reservation information 810 located at the beginning of the automatic reservation list information 800, which can facilitate the process for retrieving the automatic reservation information 810. Thus, the recording reservation setting section 293 can effectively perform the process for judging the overlapping state.

The reservation information incorporating section 292 sorts the automatic reservation information 810 incorporated in the manual reservation list information 700 in the order of the recording start date/time from the earliest to latest. Then, the recording reservation setting section 293 judges the overlapping state with the automatic reservation information 810 sequentially from the manual reservation information 710 located at the beginning of the manual reservation list information 700, i.e. the manual reservation information 710 of which recording start date/time is the earliest. Thus, after judging the overlapping state with the manual reservation information 710 of which recording start date/time is later than the picture recording end date/time of the automatic reservation information 810, the recording reservation setting section 293 determines that there is no overlapping manual reservation information 710 subsequent to this manual reservation information 710, ending the process for judging the overlapping state. Specifically, for example, as shown in FIG. 2, when the reservation information 710, 810 is respectively incorporated in the manual reservation list information 700 and the reservation information temporary storage region 283, after the overlapping state with the manual reservation information 710 located at the second position from the beginning in the manual reservation list information 700 is judged, it can be determined that there is no manual reservation information 710 overlapping with the automatic reservation information 810 after the third position or later, ending the process for judging the overlapping state. Thus, the recording reservation setting section 293 can effectively perform the process for judging the overlapping state.

The recording reservation setting section 293 retrieves the automatic reservation information 810 of which recording start date/time is the earliest from the automatic reservation list information 800, and judges the overlapping state between the retrieved automatic reservation information 810 and the manual reservation information 710. Accordingly, the recording reservation setting section 293 can judge the overlapping state sequentially from the automatic reservation information 810 that corresponds to the automatic recording reservation to be performed in the nearest future, i.e. from the automatic reservation information 810 of which overlapping state has to be judged earliest. Thus, the recording reservation setting section 293 can properly perform the process for judging the overlapping state.

The recording reservation setting section 293 stores the retrieved automatic reservation information 810 in the reservation information temporary storage region 283, and judges the overlapping state between the stored automatic reservation information 810 and the manual reservation information 710. Thus, since the recording reservation setting section 293 can store the automatic reservation information 810 of which recording start date/time is the earliest in the reservation information temporary storage region 283 for a long period of time, when, for example, it is recognized that the manual reservation information 710 of the manual reservation list information 700 is sorted by the reservation information incorporating section 292, the automatic reservation information 810 does not need to be newly retrieved. Accordingly, the processing load of the recording reservation setting section 293 at the time of judging the overlapping state can be reduced.

### Modifications of Embodiments

Though the present invention has been described above with reference to a preferred embodiment, the scope of the invention is not limited to the embodiment but includes various improvements and variations in the design as long as an object of the present invention can be achieved.

In the embodiment, the recording reservation setting section 293 retrieves the automatic reservation information 810 based on the recording start date/time information. However, the present invention is not restricted thereto, and any embodiment in which the automatic reservation information 810 is retrieved based on the order of generation by the reservation information generating section 291 may be employed, for instance. Also in this arrangement, the number of steps in the process for judging the overlapping state and the time required for judging can be reduced as compared with the conventional arrangement. Accordingly, the storing/reproducing apparatus 200 can properly set the recording reservation, and thus can properly retrieve the contents data of the contents reserved for recording.

In the embodiment, the reservation information incorporating section 292 sorts the automatic reservation information 810 set in the automatic reservation list information 800 in the order of the recording start date/time from the earliest to latest, and the recording reservation setting section 293 retrieves the automatic reservation information 810 located at the beginning of the automatic reservation list information 800. However, the present invention is not restricted thereto, and the following arrangements can be also employed. Specifically, the reservation information incorporating section 292 stores order information as selection information indicative of the order of the recording start date/time relate after associating with the respective automatic reservation information 810. Then, the recording reservation setting section 293 may retrieve the automatic reservation information 810 based on the order information. In this arrangement, the reservation information incorporating section 292 can allow the recording reservation setting section 293 to properly store the automatic reservation information 810 by only performing the process for associating the order information which requires smaller processing load than that of sorting the automatic reservation information 810. Thus, the storing/reproducing apparatus 200 can properly set the recording reservation.

In the embodiment, the recording reservation setting section 293 retrieves the automatic reservation information 810 of which the recording start date/time is the earliest. However, the present invention is not restricted thereto, and the following arrangement can be employed, for instance. Specifically, the contents information concerning the details of contents may be incorporated in the manual reservation information 710 and the automatic reservation information 810, and the overlapping state may be judged in accordance with the details of the contents information. In this arrangement, in the storing/reproducing apparatus 200, the number of the steps in the process for judging the overlapping state of the details of contents that are manually reserved or automatically reserved for recording can be reduced as well as time required for the judging can be shortened as compared with the conventional arrangement. Accordingly, the storing/reproducing apparatus 200 can properly set the recording reservation, and thus can properly retrieve the contents data of the contents reserved for recording.

In the embodiment, the recording reservation setting section 293 stores the retrieved the automatic reservation information 810 in the reservation information temporary storage region 283. However, the present invention is not restricted thereto, and the following arrangement can be employed, for example. Concretely, the reservation information temporary storage region 283 may not be provided in the memory 280, and the automatic reservation information 810 may be retrieved from the automatic reservation list information 800 every time when the recording reservation setting section 293 performs the process for judging the overlapping state. This arrangement does not require the reservation information temporary storage region 283 in the memory 280. Accordingly, the storage capacity of the manual reservation list storage region 281 and the automatic reservation list storage region 282 can be enlarged, which enabling more manual reservation information 710 and automatic reservation information 810 to be stored.

In the embodiment, when it is determined that the recording reservation of the automatic reservation information 810 stored in the reservation information temporary storage region 283 does not overlap with the recording reservation of all the manual reservation information 710 incorporated in the manual reservation list information 700, the recording reservation setting section 293 ends the process for setting the recording reservation. However, the present invention is not restricted thereto, and the following arrangement can be employed, for instance. Specifically, when it is determined that the recording reservation does not overlap, the automatic reservation information 810 stored in the reservation information temporary storage region 283 is incorporated in the manual reservation list information 700 as the manual reservation information 710. Thereby, when performing the recording reservation, the recording controller 294 only needs to refer to the manual reservation information 710 incorporated in the manual reservation list information 700, and does not need to refer to the reservation information temporary storage region 283 unlike the above-described embodiment. Accordingly, the processing load of the recording controller 294 can be reduced, and the contents data of the contents reserved for recording can be appropriately retrieved.

In the embodiment, the processing controller and the data processor of the present invention are applied to the storing/reproducing apparatus 200 that records the contents data. However, the present invention is not restricted thereto. For example, the data to be stored may include a radio broadcasting program, a satellite broadcasting program, etc. in addition to the TV broadcasting program. Furthermore, the processing controller and the data processor may not be applied to the storing/reproducing apparatus 200, and a recording apparatus only for storing the data or an independent processing controller that manages information concerning the recording reservation made to the recording apparatus and the storing/reproducing apparatus 200 may be alternatively employed.

In the embodiment, the above-described respective functions are embedded in a form of programs. However, those functions may be embedded as hardware such as a circuit board and an element of an IC (Integrated Circuit) or the like, and any arrangement can be employed. By employing the arrangement in which the functions are read out from programs or other recording medium, handling becomes easy and usability can be improved.

Incidentally, a concrete structure and procedure of the embodiment of the present invention can be changed as long as the present invention can be achieved.

### Advantages of Embodiments

As described above, according to the present embodiment, in the storing/reproducing apparatus 200, when the reservation information generating section 291 of the CPU 290 retrieves the manual recording reservation request information, the manual reservation information 710 having written therein the recording start date/time information, recording end date/time information, etc. is generated. Then, the CPU 290 incorporates the manual reservation information 710 in the manual reservation list information 700 by means of the reservation information incorporating section 292. When the CPU 290 retrieves the automatic recording reservation request information by means of the reservation information generating section 291, the CPU 290 generates, based on the keyword of the automatic recording reservation request information and the EPG data being stored in the HDD 270, the automatic reservation information 810 having written therein the recording start date/time information, recording end date/time information, etc. of the contents of the program corresponding to the recognized keyword. Then, the reservation information incorporating section 292 incorporates the automatic reservation information 810 in the automatic reservation list information 800. Subsequently, the recording reservation setting section 293 retrieves one automatic reservation information 810 from the automatic reservation list information 800, and judges the overlapping state of the recording between the automatic reservation information 810 and the manual reservation information 710 incorporated in the manual reservation list information 700. When it is determined that there is no overlapping, the recording reservation setting section 293 ends the process for setting recording reservation without deleting the automatic reservation information 810, while when it is determined that there is overlapping, the section 293 deletes the automatic reservation information 810 from the memory 280, retrieves another automatic reservation information 810 and performs the above-described process.

Accordingly, since the CPU 290 of the storing/reproducing apparatus 200 judges the overlapping state between the one automatic reservation information 810 retrieved from the automatic reservation list information 800 and the manual reservation information 710 of the manual reservation list information 700 by means of the recording reservation setting section 293, the number of the steps in the process for judging the overlapping state can be reduced as compared with the conventional arrangement in which the overlapping state with all the reservation information 710, 810 stored in the memory 280 is judged. Accordingly, the storing/reproducing apparatus 200 can properly set the recording reservation, and thus can properly retrieve the contents data of the contents reserved for recording.

The priority application Number JP2004-164932 upon which this patent application is based is hereby incorporated by reference.

1. A processing controller that controls a data retriever for retrieving data to retrieve the predetermined data, comprising:
a request information retrieving section that retrieves request information for requesting the data related to a specific detail or the data related to a prespecified detail to be retrieved by the data retriever;
a detail information retrieving section that retrieves detail information corresponding and relating to the detail of the data to be retrieved by the data retriever based on the request information;
a list table establishing section that establishes a first list table of table structure in which a plurality of the detail information corresponding to the data of the specific detail can be listed and a second list table of table structure in which a plurality of the detail information corresponding to the data of the predetermined detail can be listed;
a selecting section that selects and retrieves one of the detail information listed in the second list table;
a judging section that judges an overlapping state between the detail information listed in the first list table and the detail information selected by the selecting section; and
a retrieving controller that controls the data retriever to retrieve the data based on the detail information listed in the first list table and the detail information selected by the selecting section when the judging section judges that the details do not overlap and controls the selecting section to select another detail information when the judging section judges that the details overlap.

2. The processing controller according to claim 1, wherein
the selecting section selects and retrieves one of the detail information based on the detail of the detail information listed in the second list table.

3. The processing controller according to claim 1, wherein
the list table establishing section establishes the second list table in a table structure in which the detail information corresponding to the data of the predetermined data is listed in the order based on the detail of the detail information, and
the selecting section selects and retrieves the detail information from the detail information listed in the second list table in accordance with the order of the table structure.

4. The processing controller according to claim 1, wherein
the list table establishing section establishes the first list table in a table structure in which the detail information corresponding to the data of the specific detail is listed in the order based on the detail of the detail information, and
the judging section judges the overlapping state of the detail information selected by the selecting section based on the order of the detail information listed in the first list table.

5. The processing controller according to claim 1, wherein
the list table establishing section associates one of the detail information with selection information indicating that the detail information is to be selected by the selecting section based on the detail of the detail information corresponding to the data of the predetermined detail, and
the selecting section selects and retrieves the detail information associated with the selection information.

6. The processing controller according to claim 1, wherein
the detail information includes delivery time information concerning a delivery time of the data, and
the selecting section selects and retrieves the detail information corresponding to the delivery time information of which delivery time is the earliest from the detail information listed in the second list table.

7. The processing controller according to claim 1, wherein
the selecting section establishes a selected-object information table of table structure in which the one selected and retrieved detail information can be listed, and
the judging section judges the overlapping state between the detail information listed in the first list table and the detail information listed in the selected-object information table.

8. The processing controller according to claim 7, wherein
the judging section judges the overlapping state of delivery time zones based on the delivery time information which is related to the delivery time of the data and written in the detail information.

9. The processing controller according to claim 1, wherein
the retrieving controller controls the selecting section to establish the first list table by listing the detail information judged by the judging section that the detail thereof does not overlap and selected by the selecting section and controls the data retriever to retrieve the data based on the first list table.

10. A data processor, comprising:
a data retriever for retrieving data;
a processing controller that controls the data retriever to retrieve the predetermined data; and
a storing section for storing the data retrieved by the data retriever, the processing controller comprising:
a request information retrieving section that retrieves request information for requesting the data related to a specific detail or the data related to a prespecified detail to be retrieved by the data retriever;
a detail information retrieving section that retrieves detail information corresponding and relating to the detail of the data to be retrieved by the data retriever based on the request information;
a list table establishing section that establishes a first list table of table structure in which a plurality of the detail information corresponding to the data of the specific detail can be listed and a second list table of table structure in which a plurality of the detail information corresponding to the data of the predetermined detail can be listed;
a selecting section that selects and retrieves one of the detail information listed in the second list table;
a judging section that judges an overlapping state between the detail information listed in the first list table and the detail information selected by the selecting section; and
a retrieving controller that controls the data retriever to retrieve the data based on the detail information listed in the first list table and the detail information selected by the selecting section when the judging section judges that the details do not overlap and controls the selecting section to select another detail information when the judging section judges that the details overlap.

11. A processing controlling method for controlling a data retriever for retrieving data to retrieve the predetermined data using an operating section, the method comprising the steps of the operating section:
retrieving request information for requesting the data related to a specific detail or the data related to a prespecified detail to be retrieved by the data retriever;
retrieving detail information corresponding and relating to the detail of the data to be retrieved by the data retriever based on the request information;
establishing a first list table of table structure in which a plurality of the detail information corresponding to the data of the specific detail can be listed and a second list table of table structure in which a plurality of the detail information corresponding to the data of the predetermined detail can be listed;
selecting and retrieving one of the detail information listed in the second list table;
judging an overlapping state between the detail information listed in the first list table and the detail information selected by the selecting section; and
controlling the data retriever to retrieve the data based on the detail information listed in the first list table and the detail information selected by the selecting section when the judging section judges that the details do not overlap and controlling the selecting section to select another detail information when the judging section judges that the details overlap.

12. A processing controlling program, wherein an operating section functions as:
a request information retrieving section that retrieves request information for requesting the data related to a specific detail or the data related to a prespecified detail to be retrieved by the data retriever;
a detail information retrieving section that retrieves detail information corresponding and relating to the detail of the data to be retrieved by the data retriever based on the request information;
a list table establishing section that establishes a first list table of table structure in which a plurality of the detail information corresponding to the data of the specific detail can be listed and a second list table of table structure in which a plurality of the detail information corresponding to the data of the predetermined detail can be listed;
a selecting section that selects and retrieves one of the detail information listed in the second list table;
a judging section that judges an overlapping state between the detail information listed in the first list table and the detail information selected by the selecting section; and
a retrieving controller that controls the data retriever to retrieve the data based on the detail information listed in the first list table and the detail information selected by the selecting section when the judging section judges that the details do not overlap and controls the selecting section to select another detail information when the judging section judges that the details overlap.

13. A processing controlling program, wherein an operating section executes in order to control a data retriever for retrieving data to retrieve the predetermined data the steps of:
retrieving request information for requesting the data related to a specific detail or the data related to a prespecified detail to be retrieved by the data retriever;
retrieving detail information corresponding and relating to the detail of the data to be retrieved by the data retriever based on the request information;
establishing a first list table of table structure in which a plurality of the detail information corresponding to the data of the specific detail can be listed and a second list table of table structure in which a plurality of the detail information corresponding to the data of the predetermined detail can be listed;
selecting and retrieving one of the detail information listed in the second list table;
judging an overlapping state between the detail information listed in the first list table and the detail information selected by the selecting section; and
controlling the data retriever to retrieve the data based on the detail information listed in the first list table and the detail information selected by the selecting section when the judging section judges that the details do not overlap and controlling the selecting section to select another detail information when the judging section judges that the details overlap.

14. A recording medium storing a processing controlling program, wherein the recording medium stores in a readable manner by an operating section the processing controlling program in which the operating section functions as:
a request information retrieving section that retrieves request information for requesting the data related to a specific detail or the data related to a prespecified detail to be retrieved by the data retriever;
a detail information retrieving section that retrieves detail information corresponding and relating to the detail of the data to be retrieved by the data retriever based on the request information;
a list table establishing section that establishes a first list table of table structure in which a plurality of the detail information corresponding to the data of the specific detail can be listed and a second list table of table structure in which a plurality of the detail information corresponding to the data of the predetermined detail can be listed;
a selecting section that selects and retrieves one of the detail information listed in the second list table;
a judging section that judges an overlapping state between the detail information listed in the first list table and the detail information selected by the selecting section; and
a retrieving controller that controls the data retriever to retrieve the data based on the detail information listed in the first list table and the detail information selected by the selecting section when the judging section judges that the details do not overlap and controls the selecting section to select another detail information when the judging section judges that the details overlap.

15. A recording medium storing a processing controlling program, wherein the recording medium stores in a readable manner by an operating section the processing controlling program in which the operating section executes in order to control a data retriever for retrieving data to retrieve the predetermined data the steps of:
retrieving request information for requesting the data related to a specific detail or the data related to a prespecified detail to be retrieved by the data retriever;
retrieving detail information corresponding and relating to the detail of the data to be retrieved by the data retriever based on the request information;
establishing a first list table of table structure in which a plurality of the detail information corresponding to the data of the specific detail can be listed and a second list table of table structure in which a plurality of the detail information corresponding to the data of the predetermined detail can be listed;
selecting and retrieving one of the detail information listed in the second list table;
judging an overlapping state between the detail information listed in the first list table and the detail information selected by the selecting section; and
controlling the data retriever to retrieve the data based on the detail information listed in the first list table and the detail information selected by the selecting section when the judging section judges that the details do not overlap and controlling the selecting section to select another detail information when the judging section judges that the details overlap.
